(19) United States
(12) Patent Application Publication
(10) Pub. No.: US 2006/0277518 A1
(43) Pub. Date: Dec. 7, 2006

(54) High order synthesizing method and high order synthesizing apparatus

(75) Inventors: Osamu Mitobe, Osaka (JP); Kei Yoneda, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/447,040

(22) Filed: Jun. 6, 2006

(30) Foreign Application Priority Data
Jun. 6, 2005 (JP) 2005-165380

(51) Int. Cl. G06F 17/50

(52) U.S. Cl. 716/18; 716/3

(57) ABSTRACT

A signal in a hardware description corresponding to a variable or an expression in an operation description is identified so that a tracing description for hardware description for obtaining a transition history of a signal in the hardware description corresponding to a tracing object in the operation description is generated.

### BACKGROUND OF THE INVENTION

1. Field of the Invention

The present invention relates to a high order synthesizing method for synthesizing a hardware description from an operation description, more particularly to a technology for verifying the hardware description in a design environment in which a high order synthesizing apparatus is used.

2. Description of the Related Art

A high order synthesizing method is a technology for automatically generating a logical circuit described in a hardware description language from an operation description in which a plurality of processing operations included in a circuit to be designed are described using a high order synthesizing apparatus.

In the high order synthesizing method, there is a possibility to cause penetration of a problem resulting from the high order synthesizing apparatus into the hardware description in the synthesizing process even though the operation description is accurately described. Further, there is a likelihood of generation of any unintended description due to human errors in setting restrictions to the high order synthesizing apparatus. Therefore, it is necessary to verify the generated hardware description. No. 3373641 of the Laid-Open Disclosure of Japanese Patents recites a method for generating a test vector for the hardware description from a test vector for the operation description in order to dynamically verify the hardware description generated by the high order synthesizing apparatus. As a general method for dynamic verification of the hardware description generated through the high order synthesis, a simulation is carried out in such a manner that test patterns are respectively provided for the operation description and the hardware description, and tracing results at interface parts of these descriptions are compared to each other. It takes much time to identify the problem in the hardware description when an inconsistency is detected in the comparison.

When a dynamic verification is conventionally carried out to the hardware description generated by the high order synthesizing apparatus, the simulation is conducted in such a manner that the test patterns are respectively provided for the operation description and the hardware description, and transition histories of output signals at the interface parts in these descriptions are compared to each other, so that it is verified whether or not the high order synthesizing apparatus accurately generates the hardware description.

When the transition histories of the output signals at the interface parts are inconsistent with each other, it is necessary to find out what causes the inconsistency. In order to find out the cause, it is necessary to identify a part where a computation error of the hardware description is generated retroactively from a time point on the simulation when the inconsistency is generated. However, even in a case that a wrong computation result is generated due to the computation error of the hardware description, any influence resulting from the error may not immediately appear in the transition history of the output signal in the hardware description. More specifically, even though the error is generated in the computation, the transition history at the interface part of the hardware description and the transition history at the interface part of the operation description may coincide with each other at the time point when the computation error is generated. Therefore, it becomes difficult to identify the time point when the computation error of the hardware description is generated only from the transition histories of the interface parts. As an option for dealing with the difficulty, a transition history of an internal signal in the hardware description and a transition history of a variable or an expression in the operation description corresponding to the internal signal in the hardware description are compared to each other, and a clue is picked up to identify the part of the hardware description where the computation error is generated from any part where an inconsistency is generated between them.

However, in the case of generating the hardware description from the operation description in the high order synthesizing apparatus, differences are generated in a result of allocating the variable or the expression in the operation description to the signal in the hardware description when the operation description is modified, or various restrictions set by a designer in the synthesizing operation, such as clock restriction and area restriction, are modified. More specifically, the correspondence of the variable or the expression in the operation description and the signal in the hardware description to each other is remade when the operation description or the restrictions are modified in the re-synthesizing operation. In that case, it requires an additional task to identify the signal in the hardware description corresponding to the variable in the operation description for which the transition history is desired to obtain.

As described, in the dynamic verification in the high order synthesis, the transition history of the variable or the expression in the operation description and the transition history of the signal in the hardware description are compared to each other, and it is determined that the signal in the hardware description generated by the high order synthesizing apparatus is accurately operated when the transition histories are coincident with each other. However, it is difficult in the dynamic verification to identify that the variable or the expression in the operation description corresponds to which signal in the hardware description. As a result, it becomes difficult to generate a tracing description, more specifically, a tracing description for obtaining the transition history of the signal in the hardware description corresponding to the variable or the expression in the operation description, or the like.

### SUMMARY OF THE INVENTION

Therefore, a main object of the present invention is to provide a high order synthesizing apparatus for generating a description to obtain a transition history of a signal in a hardware description corresponding to a variable or an expression in an operation description.

In order to achieve the object, a high order synthesizing apparatus according to the present invention comprises a tracing description generator for hardware description and a tracing description generator for operation description.

The tracing description generator for hardware description generates a tracing description for hardware description for obtaining a transition history of a signal showing a name of a part constituting hardware in the hardware description.

The tracing description generator for operation description generates a tracing description for operation description for obtaining a transition history of a tracing object in the operation description.

The tracing description generator for hardware description identifies a signal in the hardware description corresponding to the tracing object in the operation description to thereby generate a tracing description for hardware description for obtaining a transition history of the signal in the hardware description corresponding to the tracing object in the operation description. The tracing object here is the variable or the expression in the operation description.

The tracing description generator for hardware description can generate the tracing description for hardware description regardless of whether or not the tracing object in the operation description whose transition history is to be obtained is allocated to a register in the hardware description.

The tracing object has to be selected in order to generate the tracing description for hardware description. Therefore, the tracing objects are compiled in a list, and the list is given to the high order synthesizing apparatus. The tracing object list may be unlimitedly any list showing the tracing objects supplied from outside of the high order synthesizing apparatus. The tracing object list is more specifically a list generated in such a manner that a user selects the tracing object from the operation description, a list generated in such a manner that the user selects the tracing object from a reference information, or the like.

Here, a reference information is generated by a reference information generator provided in the high order synthesizing apparatus. The reference information generator generates the reference information from any description including information of the tracing object such as the operation description, a register allocation result, or lifetime information.

The reference information can be more specifically an information showing the tracing object corresponding to a register where a final computation result is stored, an information showing number of times when the computation result is assigned to the tracing object, an information showing the signal in the hardware description corresponding to the tracing object in the operation description, or such an information as the register allocation result and the lifetime information itself. The reference information can be any information for determining the tracing object.

The high order synthesizing apparatus comprises a tracing object list generator for generating the tracing object list in which the tracing objects are listed up. The tracing object list generator analyzes the description including the information of the tracing object such as the register allocation result, lifetime information or operation description to thereby generate the tracing object list.

The high order synthesizing apparatus analyzes the description including the information of the tracing object such as the register allocation result, lifetime information or operation description to thereby automatically acknowledge the tracing object whose transition history is to be obtained.

The outline of the present invention was described so far, and the constitution according to the present invention is described below in further detail.

A high order synthesizing method according to the present invention comprises a step for generating a hardware description wherein an operation description is converted to hardware based on the operation description in which an operation of a circuit to be designed is described, and a step for generating a tracing description for hardware description to obtaining a transition history of one or a plurality of signals in the hardware description.

In response to the method thus constituted, a high order synthesizing apparatus according to the present invention comprises a high order synthesizer for generating a hardware description wherein an operation description is converted to hardware based on the operation description in which an operation of a circuit to be designed is described, and a tracing description generator for hardware description to generate a tracing description for hardware description to obtain a transition history of one or a plurality of signals in the hardware description.

The high order synthesizing method preferably further comprises a step for generating a tracing description for operation description to produce a tracing description for operation description in order to obtain a transition history of a tracing object which is one or a plurality of variables or expressions in the operation description.

In response to the method thus constituted, a prefer embodiment in the high order synthesizing apparatus further comprises a tracing description generator for operation description to generate a tracing description for operation description for obtaining a transition history of a tracing object which is one or a plurality of variables or expressions in the operation description.

Further, there are some preferable embodiments as shown below in the step to generate the tracing description for hardware description in the high order synthesizing method. Namely, the preferable embodiment in the step generates the tracing description for hardware description for obtaining the transition history of the signal in the hardware description corresponding to the tracing object which is one or a plurality of variables or expressions in the operation description.

In response to this, the preferable conformation in the high order synthesizing apparatus mentioned above is the embodiment wherein the tracing description generator for the hardware description generates the tracing description for hardware description for obtaining the transition history of the signal in the hardware description corresponding to the tracing object which is one or a plurality of variables or expressions in the operation description.

Further, the preferable conformation in the step for generating the tracing description for hardware description is the embodiment wherein the tracing description for hardware description is generated from the register allocation result showing the correspondence relationship between the tracing object allocated to the register included in the hardware description and the register.

In response to this, the preferable conformation in the high order synthesizing apparatus is the embodiment wherein the tracing description generator for hardware description generates the tracing description for hardware description from the register allocation result showing the correspondence relationship between the tracing object allocated to the register included in the hardware description and the register.

Further, the preferable conformation in the step to generate the tracing description for hardware description is the embodiment wherein the tracing description for hardware description is generated from a lifetime information showing a time length when the tracing object corresponding to the signal in the hardware description is used for the computation in the hardware description and a data path correspondence information showing a correspondence relationship between the tracing object and the signal in the hardware description.

In response to this, the preferable conformation in the high order synthesizing apparatus is the embodiment wherein the tracing description generator for hardware description generates the tracing description for hardware description from a lifetime information showing a time length when the tracing object corresponding to the signal in the hardware description is used for the computation in the hardware description and a data path correspondence information showing the correspondence between the tracing object and the signal in the hardware description.

Further, it is preferable that the tracing object list in which the tracing objects are listed up is used in the high order synthesizing method mentioned above. In this case which case the high order synthesizing method is further preferable to include a step for generating the tracing object list in which the tracing objects are listed up.

Further, it is preferable that a step for generating the reference information for determining the tracing object is further included in the high order synthesizing method. The tracing object list in which the tracing objects are listed up is preferably generated in such a manner that the user selects the tracing object based on the reference information for determining the tracing object. The trace object is preferably automatically acknowledged.

The tracing object list is preferably generated in such a manner that the user selects the tracing object from the operation description. It is preferable that the step to generate the tracing object list generates the tracing object list by analyzing the operation description including the description for obtaining the transition history of the tracing object. Further, the step to generate the tracing object list preferably generates the tracing object list by analyzing the register allocation result showing the correspondence relationship between the tracing object allocated to the register included in the hardware description and the register. In addition, the step to generate the tracing object list preferably generates the tracing object list by analyzing the lifetime information showing the time length when the tracing object corresponding to the signal in the hardware description is used in the computation of the hardware description.

Further it is preferable that the step to generate the reference information generates the reference information from the register allocation result showing the correspondence relationship between the tracing object allocated to the register included in the hardware description and the register. Moreover it is preferable that the step to generate the reference information generates the reference information from the lifetime information showing the time length when the tracing object corresponding to the signal in the hardware description is used in the computation of the hardware description. The step to generate the reference information preferably generates the reference information from the operation description including the description for obtaining the transition history of the tracing object.

The tracing object is preferably automatically acknowledged by analyzing the operation description including the description for obtaining the transition history of the tracing object.

It is preferable that the tracing object is automatically acknowledged by analyzing the register allocation result showing the correspondence relationship between the tracing object allocated to the register included in the hardware description and the register.

It is preferable that the tracing object is automatically acknowledged by analyzing the lifetime information showing the time length when the tracing object corresponding to the signal in the hardware description is used in the computation of the hardware description.

A technical problem in the conventional technology is that it is difficult to identify which signal in the hardware description the tracing object in the operation description corresponds to in the case of carrying out a dynamic verification whether or not the signal in the hardware description generated through the high order synthesis is accurately operated, which makes it difficult to generate the tracing description for hardware description.

On the contrary, according to the present invention constituted described so far, the tracing description for hardware description for obtaining the transition history of the signal in the hardware description is generated by identifying the signal in the hardware description corresponding to the tracing object in the operation description. Thus, the problem in the conventional technology can be solved, and a debugging efficiency can be thereby improved.

Further, according to the present invention, the tracing description for operation description and the tracing description for hardware description can be automatically generated, which effectively reduces a time length required for building an environment for the verification in contrast to the conventional technology wherein the tracing description was manually prepared. As an additional advantage, a bug can be prevented from intruding because there is no manual treatment in the generation of the tracing description.

There is a case that the tracing description is described in the operation description in order to confirm whether or not the operation description is accurately operated. The tracing description in the operation description shows the tracing object for which the transition history is desirably obtained. The construction according to the present invention is adapted to analyze the operation description including the tracing description. Therefore, the tracing description for hardware description can be generated directly from the operation description in which the tracing description is described, which makes it unnecessary to explicitly shows the tracing object for which the transition history is desirably obtained in the high order synthesizing apparatus. As a result, the time length required for building the environment for the verification can be effectively reduced.

Further, the information showing the tracing object, such as the register allocation result or the lifetime information generated when the hardware description is generated from the operation description by the high order synthesizing apparatus, is used to automatically select the tracing object which is effective in terms of the verification. Thereby, an efficiency of the verification is improved because a number of steps is reduced when the user selects the tracing object.

When the user selects the tracing object in the operation description, a particular tracing object is selected from all of the tracing objects in the operation description. When a magnitude of the operation description is increased, however, the number of the tracing objects in the operation description is accordingly increased, which makes it difficult to select the particular tracing object among them. Therefore, according to the present invention, the reference information relating to the tracing object is generated from the information showing the tracing object, such as the register allocation result, lifetime information or operation description. The user can use the reference information to support the selection process of in selection the tracing object for which the transition history is desirably obtained. As a result, the selection of the tracing object can be facilitated.

Further, as the expression in the operation description, in addition to the variable, can be traced, any computation result can be thus traced independently from a description format of the operation description, which improves the efficiency of the verification.

The technology according to the present invention can be effectively used for the dynamic verification of the hardware description generated by the high order synthesizing apparatus comprising the tracing description generator for hardware description and the tracing description generator for operation description.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 shows a conceptual diagram for a constitution of a high order synthesizing apparatus according to a preferred embodiment 1 of the present invention.

FIG. 2 shows an example of a tracing description for hardware description according to the preferred embodiment 1.

FIG. 3 shows an example of a tracing description for operation description according to the preferred embodiment 1.

FIG. 4 shows an example of an operation description in which a number of computations are described in one line according to the preferred embodiment 1.

FIG. 5 shows an example of a lifetime information relating to expressions according to the preferred embodiment 1.

FIG. 6 shows a register allocation result showing a correspondence relationship between the expressions and the register according to the preferred embodiment 1.

FIG. 7 shows an example of a tracing description for operation description for obtaining a transition history of the expression according to the preferred embodiment 1.

FIG. 8 shows a conceptual diagram for a constitution of a high order synthesizing apparatus according to a preferred embodiment 2 of the present invention.

FIG. 9 shows a reference information according to the preferred embodiment 2.

FIG. 10 shows a conceptual diagram for a constitution of a high order synthesizing apparatus according to a preferred embodiment 3 of the present invention.

FIG. 11 shows an example of an operation description including a tracing description for obtaining a transition history of a tracing object according to the preferred embodiment 3.

FIG. 12 is a flow chart illustrating an operation of a tracing object list generator according to the preferred embodiment 3.

FIG. 13 shows a conceptual diagram for a constitution of a high order synthesizing apparatus according to a preferred embodiment 4 of the present invention.

FIG. 14 shows a conceptual diagram for a constitution of a high order synthesizing apparatus according to a preferred embodiment 5 of the present invention.

FIG. 15 shows an example of a tracing description for hardware description according to the preferred embodiment 5.

FIG. 16 shows an example of a tracing description for operation description according to the preferred embodiment 5.

FIG. 17 shows an example of an operation description in high order synthesis.

FIG. 18 shows an example of a scheduling processing in the high order synthesis.

FIG. 19 shows an example of a lifetime information in the high order synthesis.

FIG. 20 shows an example of a register allocation result in the high order synthesis.

FIG. 21 shows an example of a data path generation result in the high order synthesis.

FIG. 22 shows an example of a data path correspondence information in the high order synthesis.

### DETAILED DESCRIPTION OF THE INVENTION

Hereinafter, preferred embodiments of the present invention are described referring to the drawings. A tracing description for operation description is a description for obtaining a transition history of a tracing object in the operation description. A tracing description for hardware description is a description for obtaining a transition history of a signal in the hardware description corresponding to the tracing object. The preferred embodiments of the present invention show a method for generating the tracing description for operation description and the tracing description for hardware description using a high order synthesizing apparatus. The present invention is described referring to a simple operation description.

Before the preferred embodiments of the present invention are described, a basic constitution of a high order synthesizing method according to the present invention is described. As an example of the basic constitution, a high order synthesizing method for an operation description shown in FIG. 17 which is described in the ANCIC language is explained referring to FIGS. 17-22.

In the operation description shown in FIG. 17, variables “a”, “b” and “c” are inputs, and variables “d” and “e” are used for storing an intermediate computation result before a final result is obtained. The final computation result is assigned to the variable “b”. In the operation description shown in FIG. 17, first, the variables “a” and “b” are added to each other, and a result of the addition is assigned to the variable “d”. Further, the variable “c” is multiplied by the variable “d” which is the adding result obtained earlier, and a result of the multiplication is assigned to the variable “e”. Further, the variable “a” and the variable “e” which is the multiplying result obtained earlier are added to each other, and a result of the addition is assigned to the variable “b”.

Scheduling

In the high order synthesis, the operation description is generally converted into a model showing a relationship depending on an execution order in computations called the control data flow graph (hereinafter, referred to as CDFG). Then, a scheduling processing is executed so as to satisfy the restrictions for an area and a clock frequency supplied by a user in the high order synthesis. In the scheduling processing, control steps for executing the computations appearing in the CDFG are determined. In the scheduling processing, nodes representing the computations in the CDFG are allocated to the control steps so that the data dependence relationship and the restrictions are satisfied.

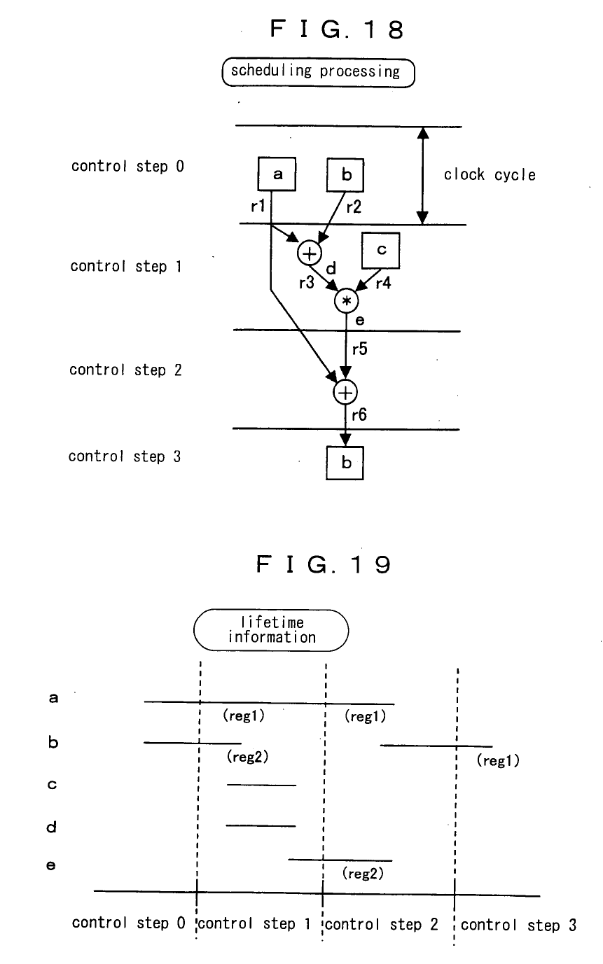

FIG. 18 shows a result obtained by executing the scheduling processing to the operation description shown in FIG. 17. In FIG. 18, the variables “a” and “b” are allocated to a control step 0. The addition, d=a+b, in FIG. 17, the input variable “c”, and the multiplication, e=c*d, in FIG. 17 are allocated to a control step 1. The addition, b=a+e, in FIG. 17 is allocated to a control step 2. The variable “b”, which is the final result, is allocated to a control step 3. In the CDFG, a data dependence branch showing the data dependence relationship is used to connect the respective computations in accordance with the order of the operation description. In the result obtained by the scheduling processing shown in FIG. 18, edges r1, r2, r3, r4, r5 and r6 are the data dependence branches.

Allocation

Next, an allocation processing is executed based on the scheduling processing result obtained in FIG. 18. The allocation processing is a processing in which the computations of the CFFG are allocated to a computation device, the data dependence branch traversing a clock boundary of the adjacent steps is allocated to the register, and an input and an output are allocated to input and output pins. In the allocation processing, a circuit construction capable of realizing the operation of the operation description is determined in consideration of a hardware volume. A circuit at a register transfer level (RTL) requires such components as the computation device, register, and input and output pins.

In the allocation processing of the computation device, the computation device, which executes the relevant computation, is supplied to each computation in the CDFG. In the CDFG, resources (adder and the like) can be shared even if there is a plurality of same computations unless there are present in the same control step. For example, in the allocation processing of the computation device shown in FIG. 18, there are two additions in the CDFG, however, these two additions belong to the different control steps. Therefore, the same adder can be allocated thereto. However, in the case of the multiplication, one multiplier is allocated to one multiplication.

Next, in the allocation processing of the register, the register is allocated to any data dependence branch intersecting with the clock boundary. However, if all of the data dependence branches are allocated to the registers, a hardware cost is inevitably increased. Therefore, a plurality of variables is allocated to each register so that the number of the registers can be reduced.

In the case of allocating the variable or an expression in the operation description to the register, a lifetime information is utilized. The lifetime information represents a time length when the variable or expression is used in a computation of a hardware description 20. The variable and expression recited here denote a variable and an expression present in the operation description corresponding to a signal in the hardware description 20. In the lifetime information thus constituted, there is no overlap of the lifetime. In other words, any variable and expression which are not possibly used at the same time can be allocated to the same register.

FIG. 19 shows a result obtained by arranging the variable or expression in the CDFG in FIG. 18 subjected to the scheduling processing in accordance with an order of start times of the lifetime. The variable “a” is used during a time interval from the control step 0 through the control step 2. The variable “b” is used during a time interval from the control step 0 through the control step 1 and a time interval from the control step 2 through the control step 3. The variable “c” is used during a time interval of the control step 1. The variable “d” is used during the time interval of the control step 1. The variable “e” is used during a time interval from the control step 1 through the control step 2. Of these variables, it is necessary to allocate any variable traversing the clock boundary to the register. In FIG. 19, the variable traversing the clock boundary is the variables “a”, “b” and “e”.

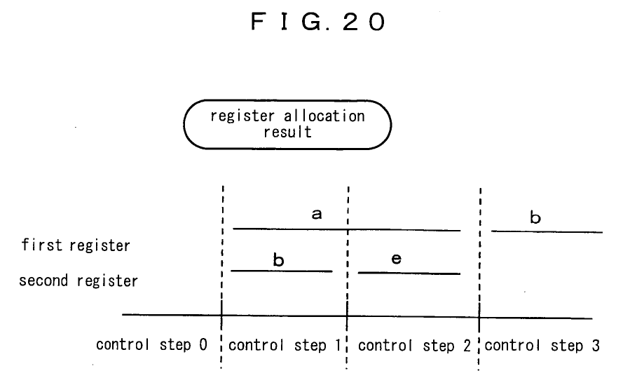

While the lifetime information is sequentially being checked, the variables are allocated to the registers unless the lifetime overlaps. FIG. 20 shows a result of the register allocation. The register allocation result shows the result obtained by allocating the registers based on the lifetime information shown in FIG. 19.

In the control step 1, the variable “a” is allocated to a first register, and the variable “b” is allocated to a second register respectively. In the control step 2, the variable “a” is allocated to the first register in succession to the control step 1. The variable “e” which retains the adding result and the multiplying result in the control step 1 is allocated to the second register. The variable “c” is inputted directly from outside in the control step 1. The variable “d” is not allocated to any register because the variable “d” shows the intermediate computation result and does not traverse the clock boundary (see FIG. 19). In the control step 3, the variable “b”, which shows the final computation result, is allocated to the first register.

Data Path Generation

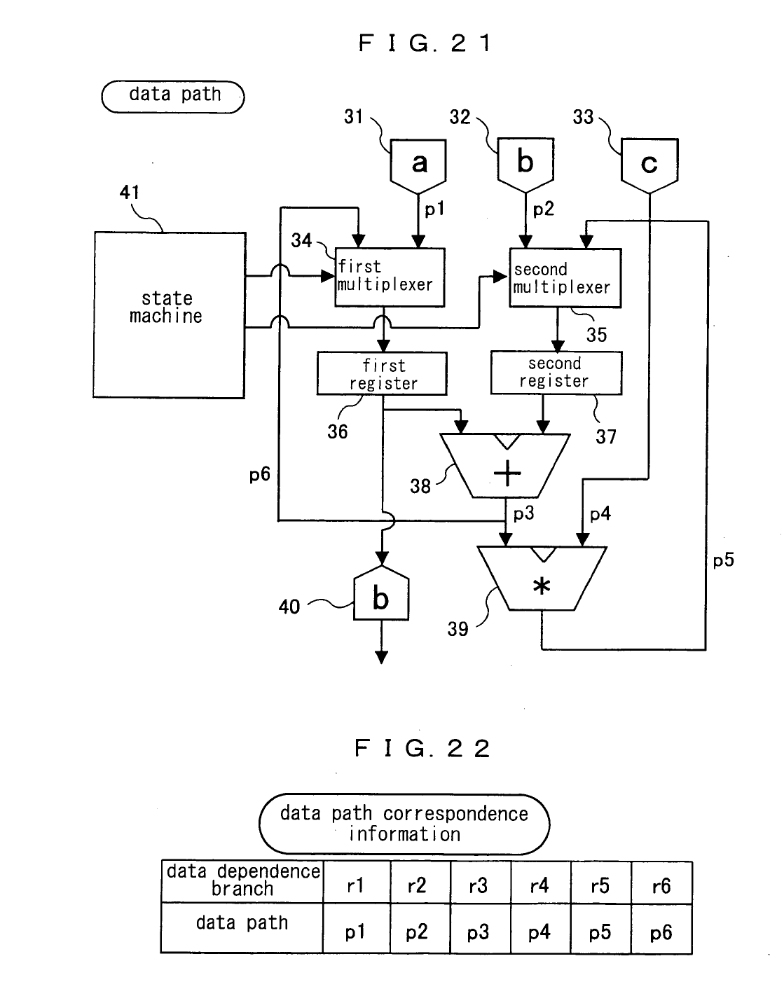

After the allocating processing, data paths are generated and circuit paths corresponding to the CDFG are generated. The generated data paths are shown in FIG. 21. In the data paths shown in FIG. 21, an adder 38 and a multiplier 39 are generated, and a first register 36 and a second register 37 are generated.

Input pins 31, 32 and 33 shown in the data paths in FIG. 21 are allocated respectively to the three inputs “a”, “b” and “c” in the CDFG shown in FIG. 18, and an output pin 40 is allocated to the output “b” in the CDFG shown in FIG. 18.

In the case of sharing the computation device and the register, it is necessary to generate a multiplexer to be able to select the input path to the computation device and the register. A first multiplexer 34 is generated in the first register 36, and a second multiplexer 35 is generated in the second register 37.

In the generation of the data paths, the generated computation device, registers, input and output ports and multiplexers are wired one another. The generated components are connected to one another so as to correspond to the data dependence branches in the CDFG shown in FIG. 18. For example, the data path corresponding to the path on the CDFG passing through the data dependence branch r1 from the input “a” of the CDFG in FIG. 18 and inputted to the adding computation goes through the first multiplexer 34 from the input pin 31 and becomes a path of the first register 36. In a similar manner, the data paths corresponding to all of the data dependence branches are generated.

FIG. 22 shows a data path correspondence information indicating a correspondence relationship between the data dependence branches shown in FIG. 18 and the data paths shown in FIG. 21. FIG. 22 shows that the data dependence branches r1, r2, r3, r4, r5 and r6 respectively correspond to the data paths p1, p2, p3, p4, p5 and p6 shown in FIG. 21.

State Machine Generation

Next, a state machine 41 shown in FIG. 21 is generated so that the value stored in the registers at the respective control steps are appropriately selected by the multiplexers 34 and 35.

In the high order synthesis, the hardware description for realizing the operation description is generated as a result of the foregoing processing. The hardware description is generated in the high order synthesis through the processing mentioned above.

However, a problem resulting from a high order synthesizing apparatus may possibly enter the hardware description in the synthesizing process even though the operation description is accurately described. Further, any unintended description may possibly be generated due to human errors in giving the restrictions to the high order synthesizing apparatus. Therefore, it is necessary to verify the generated hardware description. The preferred embodiments of the present invention described below solve the inconveniences of the conventional technology.

### Preferred Embodiment 1

A high order synthesizing method according to a preferred embodiment 1 of the present invention is a method for generating a tracing description for hardware description by identifying a register in a hardware description corresponding to a tracing object in an operation description selected by a user.

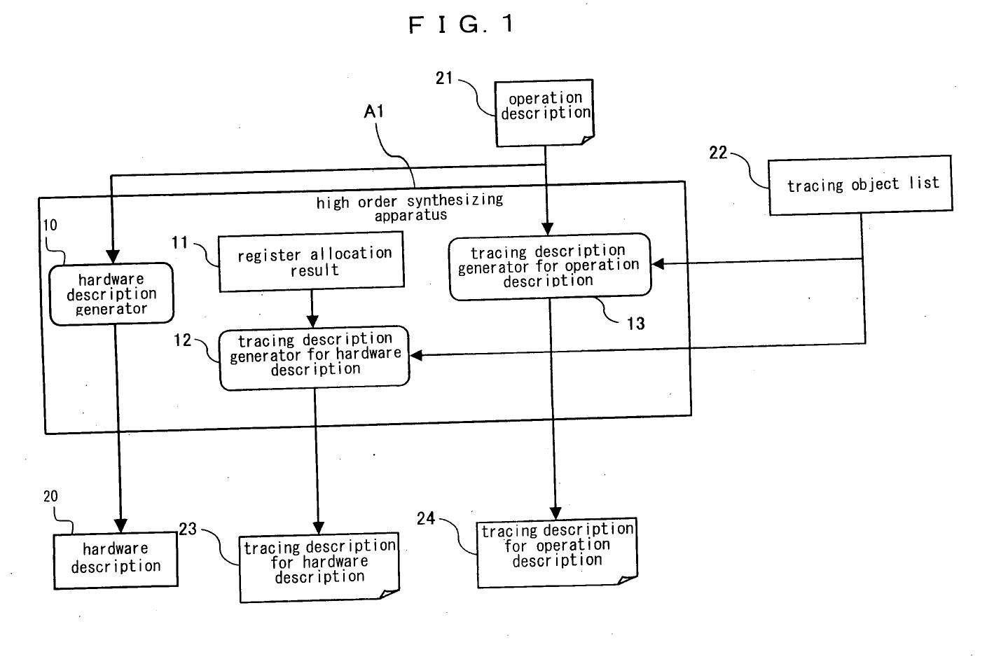

FIG. 1 shows a conceptual diagram for a constitution of a high order synthesizing apparatus according to the preferred embodiment 1. In FIG. 1, a high order synthesizing apparatus Al comprises a hardware description generator 10, a tracing description generator for hardware description 12, and a tracing description generator for operation description 13. The hardware description generator 10 generates a hardware description 20 from an operation description 21 in which an operation of a circuit to be designed is described. The tracing description generator for hardware description 12 generates a tracing description for hardware description 23 from a register allocation result 11 and a tracing object list 22. Here, the tracing object list 22 is generated in such a manner that the user selects the tracing object from the operation description 21. The register allocation result 11 is information showing a correspondence relationship between the tracing object allocated to the register and the register in the hardware description 20. Further, the tracing description generator for operation description 13 generates a tracing description for operation description 24 from the operation description 21 and the tracing object list 22.

The operation description 21, tracing object list 22 and register allocation result 11 are stored in a memory region accessible by a computer device. The computer device accesses the memory region to thereby execute the processing of the tracing description generator for hardware description 12, tracing description generator for operation description 13 and hardware description generator 10 using an internal CPU thereof, and outputs the generated tracing description for hardware description 23, tracing description 24 for operation description 24 and hardware description 20 to the memory region again.

Below is given a description referring to the operation description shown in FIG. 17 (d=a+b; e=c*d; b=a+e) as an example of the operation description 21. In the present case, it is supposed that the user selects the variable “e” in the operation description shown in FIG. 17 as the tracing object whose transition history is to be obtained. However, the tracing object is not limited to the variable “e”, and the user can select any of all of the tracing objects in the operation description 21. FIG. 20 shows an example of the register allocation result 11, wherein the register allocation result generated from the lifetime information 19 by the high order synthesizing apparatus is shown. The process to prepare the register allocation result shown in FIG. 20 was described earlier.

In order to obtain the transition history of the tracing object in the operation description 21, it is necessary to identify the signal in the hardware description 20 corresponding to the tracing object. The register corresponding to the variable “e” and the control step in which the value of the variable “e” is stored in the register can be known referring to the register allocation result 11. The variable “e” is stored in the second register 37 in the control step 2 based on the register allocation result shown in FIG. 20.

Next, the tracing description generator for hardware description 12 generates the tracing description for obtaining the transition history of the variable “e” stored in the second register 37 in the control step 2.

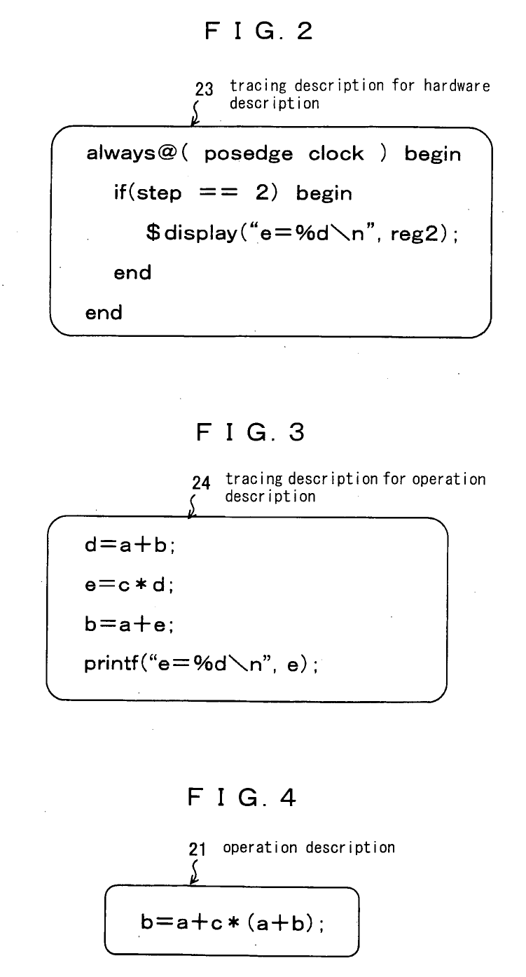

FIG. 2 shows an example of the tracing description for hardware description 23 generated by the tracing description generator for hardware description 12 in order to trace the variable “e”. In the tracing description for hardware description 23 shown in FIG. 2, the Verilog-HDL language is used as its description language.

[Clock”] in [always@(posedge clock) begin] shown in FIG. 2 represents a clock signal in the hardware description 20. [step] in [if (step==2) begin] represents the control step. [$display (“e=%d\n”, reg2);] represents the output of the transition history, and more specifically represents the output of the transition history of the value stored in the second register 37 corresponding to the variable “e” in the operation description 21. Thus, it is described in FIG. 2 that the transition history of the variable “e” stored in the second register 37 in the control step 2 is obtained.

The tracing description for hardware description 23 can be outputted from the high order synthesizing apparatus A1 in a state where it is added to the hardware description 20 generated by the high order synthesizing apparatus A1, or independently outputted from the high order synthesizing apparatus A1 as a description separate from the hardware description 20.

Further, the tracing description generator for operation description 13 generates the tracing description for operation description 24 in order to obtain the transition history of the variable “e”. FIG. 3 shows an example of the operation description 21 additionally including the tracing description 24 for operation description 24. In the tracing description 24 for operation description 24 shown in FIG. 3, the ANCIC language is used as its description language. In the operation description 21 shown in FIG. 3, the description of (printf(“e=%d\n“e);] is appended to a final line in the operation description shown in FIG. 17.

Further, the tracing description generator for hardware description 12 generates the tracing description for hardware description 23 for obtaining the transition history of the register in the hardware description 20 corresponding to the expression other than the variable. The tracing description generator for operation description 13 generates the tracing description for operation description for obtaining the transition history of the expression other than the variable. Further, the tracing description generator for operation description 13 generates the tracing description for operation description 24 for obtaining the transition history of the expression other than the variable.

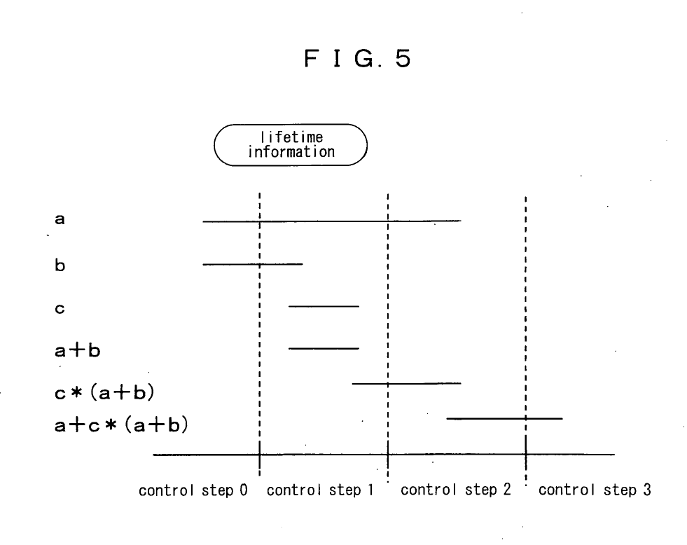

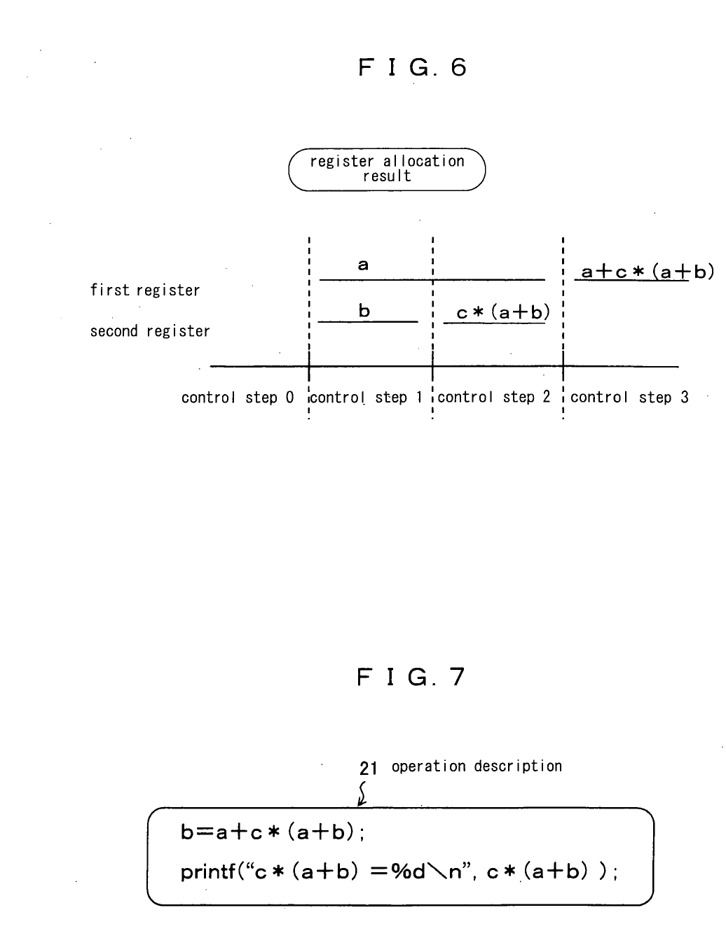

A method for generating the tracing description for obtaining the transition history of the expression is explained as an example of the operation description 21 described in the ANCIC language shown in FIG. 4. In the operation description 21 shown in FIG. 4, the same computation as that of the operation description shown in FIG. 17 is executed. As a result, the scheduling processing result of the operation description 21 shown in FIG. 4 is equal to the scheduling processing result shown in FIG. 18. Accordingly, the lifetime information in the operation description 21 shown in FIG. 4 is generated in a manner similar to the introduction of the lifetime information shown in FIG. 19. FIG. 5 shows the lifetime information generated from the operation description 21 shown in FIG. 4. Further, FIG. 6 shows the register allocation result 11 obtained from the lifetime information shown in FIG. 5.

As described, not only the variable allocated to the register, but also the expression allocated to the register, can be shown in the register allocation result 11 of FIG. 6. Thereby, the register to which the expression is allocated from the register allocation result 11 and the control step in which the relevant data is retained in the register can be identified. The tracing description generator for hardware description 12 generates the tracing description for hardware description 23 for obtaining the transition history of the register in the hardware description 20 corresponding to the expression in the operation description 21. The tracing description generator for operation description 13 generates the tracing description for operation description 24 for obtaining the transition history of the expression in the operation description 21.

Below is described an example in which the expression [c*(a+b)] is selected as the tracing object for which the transition history is obtained. It is identified by the register allocation result 11 shown in FIG. 6 that the expression is stored in the second register 37 in the control step 2. The tracing description generator for hardware description 12 generates the tracing description for hardware description 23 containing the same description as shown in FIG. 2.

FIG. 7 shows an example of the operation description 21 including the tracing description for operation description 24 generated by the tracing description generator for operation description 13. In the tracing description for operation description 24 shown in FIG. 7, the ANCIC language is used as its description language. In the operation description 21 shown in FIG. 7, a description for obtaining the transition history of the expression [c*(a+b)] is added to the operation description 21 shown in FIG. 4.

So far was described the preferred embodiment 1 referring to the simple operation description 21. In the preferred embodiment 1, the tracing description for hardware description 23 for obtaining the transition history of the tracing object can be generated in a similar manner with respect to the complicate operation description 21 containing the branches and loops.

A structure in a latter stage obtains the transition history of one through a plurality of signals in the hardware description 20 based on the tracing description for hardware description 23 outputted from the high order synthesizing apparatus according to the present preferred embodiment. Further, the structure in the latter stage obtains the transition history of the tracing object which is one through a plurality of variables or expressions in the operation description 21 based on the tracing description for operation description 24 outputted from the high order synthesizing apparatus according to the present preferred embodiment.

The transition history of the variable or the expression in the operation description 21 and the transition history of the signal in the hardware description 20, which were thus obtained, are compared to each other, and thereby the dynamic verification is carried out in the high order synthesis. In the dynamic verification, it is judged that the signal in the hardware description 20 resulting from the high order synthesis is accurately operated when the respective histories are coincident with each other.

The transition history of one through a plurality of signals in the hardware description 20 obtained based on the tracing description for hardware description 23 generated by the high order synthesizing apparatus according to the present preferred embodiment can be easily and accurately made to correspond to the transition history of the variable or the expression in the operation description 21. As a result, the transition history of the variable or the expression in the operation description 21 and the transition history of the signal in the hardware description 20 can be compared to each other with a high accuracy, which realizes the dynamic verification with a high precision.

### Preferred Embodiment 2

A high order synthesizing method according to a preferred embodiment 2 of the present invention is a method for generating the tracing description for hardware description through the user's selection of the tracing object whose transition history is to be obtained based on a reference information relating to the tracing object.

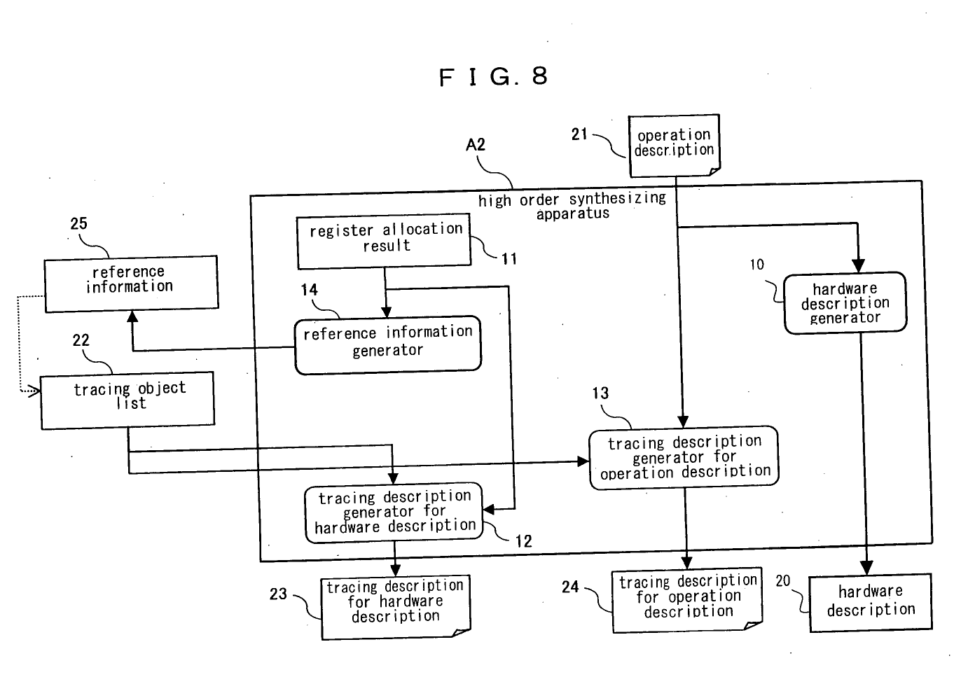

FIG. 8 shows a conceptual diagram for a constitution of a high order synthesizing apparatus according to the preferred embodiment 2. In FIG. 8, a high order synthesizing apparatus A2 comprises the hardware description generator 10, tracing description generator for hardware description 12, tracing description generator for operation description 13, and a reference information generator 14. The reference information generator 14 generates a reference information 25 as a candidate for determining the tracing object using the register allocation result 11. The reference information generator 14 generates the tracing object list 22 in such a manner that the user selects the tracing object from the generated reference information 25. The hardware description generator 10 generates the hardware description 20 from the operation description 21 in which the operation of the circuit to be designed is described. The tracing description generator for hardware description 12 generates the tracing description for hardware description 23 from the tracing object list 22 and the register allocation result 11. The tracing description generator for operation description 13 generates the tracing description for operation description 24 from the operation description 21 and the tracing object list 22.

The operation description 21, tracing object list 22, register allocation result 11 and reference information 25 are stored in a memory region accessible by a computer device. The computer device accesses the memory region to thereby execute the processing of the tracing description generator for hardware description 12, tracing description generator for operation description 13, reference information generator 14 and hardware description generator 10 using an internal CPU thereof, and outputs the tracing description for hardware description 23, tracing description for operation description 24 and hardware description 20 which are generated to the memory region again.

Below is described the present preferred embodiment referring to the operation description shown in FIG. 17 (d=a+b; e=c*d; b=a+e) as an example of the operation description 21.

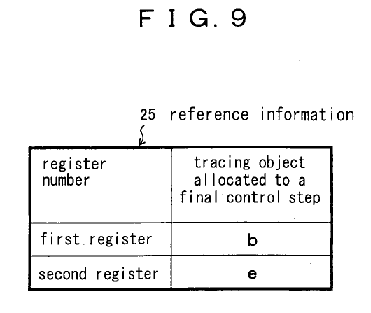

The reference information generator 14 generates the reference information 25 showing the tracing object finally allocated to each register using the register allocation result shown in FIG. 20. FIG. 9 shows an example of the reference information 25 generated by the reference information generator 14 based on the register allocation result shown in FIG. 20. In the present case, the variable “b” allocated to the final control step 3 of the first register 36 and the variable “e” allocated to the final control step 2 of the second register 37 are extracted from the register allocation result shown in FIG. 20 as the reference information 25. Through a confirmation of the transition history of the tracing object allocated to the final control step of each register, it can be confirmed that the successive computations are accurately executed after they are completed. The user selects the tracing object based on the reference information 25 to thereby generate the tracing object list 22.

The example in which the reference information generator 14 generates the reference information 25 showing the tracing object finally allocated to the control step of each register using the register allocation result 11 was described. However, the reference information generator 14 can also generate the reference information 25 for determining the tracing object from the description including the information of the tracing object such as the operation description 21 and the lifetime information other than the register allocation result 11.

Any information for determining the tracing object can be used as the reference information 25. For example, the reference information 25 is consisted of an information showing number of times when the tracing object is assigned to the register in each control step, information showing the signal in the hardware description 20 corresponding to the tracing object in the operation description 21, or such an information as the register allocation result or the lifetime information itself.

After the tracing object list 22 is prepared, the tracing description generator for hardware description 12 generates the tracing description for hardware description 23 from the tracing object list 22 and the register allocation result 11. The steps for generating the tracing description for hardware description 23 and the tracing description for operation description 24 were described in the preferred embodiment 1, and are not described again.

### Preferred Embodiment 3

A high order synthesizing method according to a preferred embodiment 3 of the present invention is a method for generating the tracing description for hardware description by analyzing the operation description 21 including the description for obtaining the transition history of the tracing object.

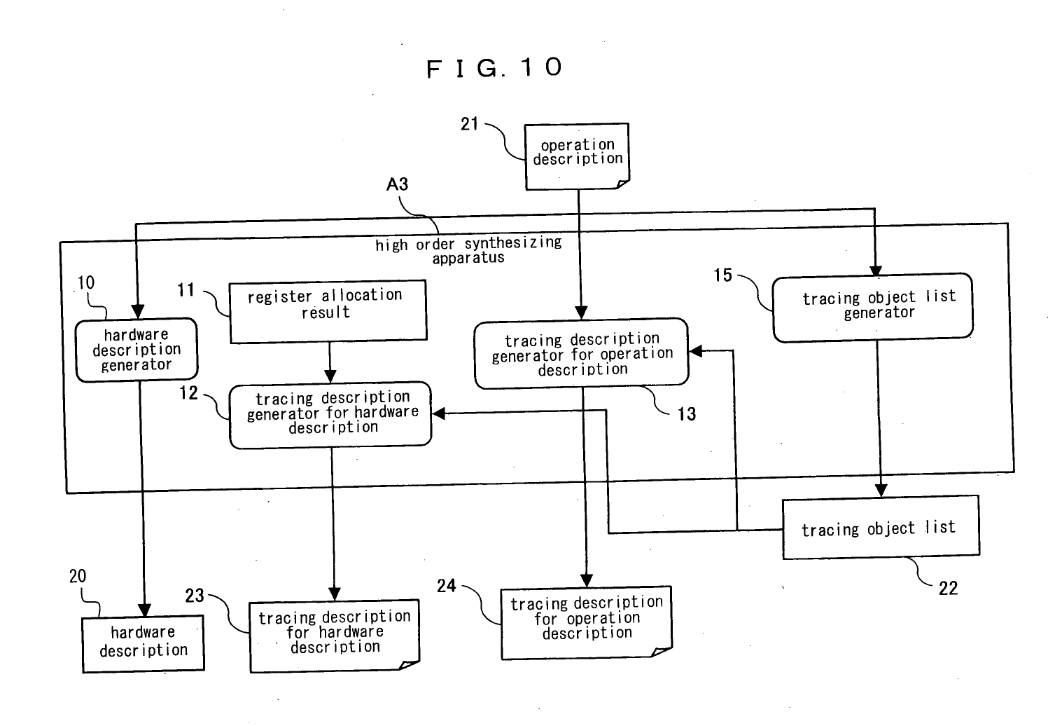

FIG. 10 shows a conceptual diagram for a constitution of a high order synthesizing apparatus according to the preferred embodiment 3. In FIG. 10, a high order synthesizing apparatus A3 comprises the hardware description generator 10, tracing description generator for hardware description 12, tracing description generator for operation description 13, and a tracing object list generator 15. The tracing object list generator 15 analyzes the operation description 21 including the tracing description for obtaining the transition history of the tracing object to thereby generate the tracing object list 22. The hardware description generator 10 generates the hardware description 20 from the operation description 21 in which the operation of the circuit to be designed is described. The tracing description generator for hardware description 12 generates the tracing description for hardware description 23 from the tracing object list 22 and the register allocation result 11. The tracing description generator for operation description 13 generates the tracing description for operation description 24 from the tracing object list 22 and the operation description 21.

The operation description 21, tracing object list 22 and register allocation result 11 are stored in the memory region accessible by the computer device. The computer device accesses the memory region to thereby execute the processing of the tracing description generator for hardware description 12, tracing description generator for operation description 13, tracing object list generator 15 and hardware description generator 10 using the internal CPU thereof to thereby generate the tracing description for hardware description 23, tracing description for operation description 24 and hardware description 20, and outputs these generated descriptions to the memory region again.

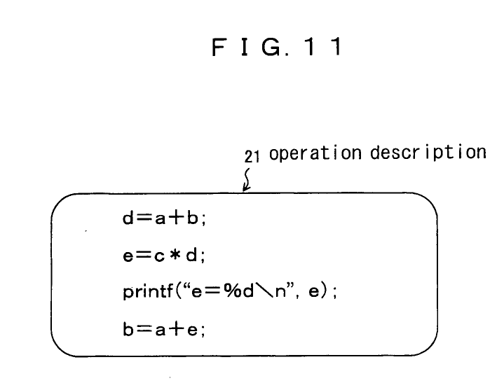

The preferred embodiment 3 is described referring to the operation description 21 in which the tracing description shown in FIG. 11 is described in the ANCIC language.

In the operation description 21 shown in FIG. 11, the value of the tracing object is standard-outputted in order to obtain the transition history of a particular tracing object. In the operation description 21 shown in FIG. 11, only the description for standard-outputting the value of the variable (third line) is additionally written in the operation description of FIG. 17, the same computations are executed except the additional description. The additional description in the operation description 21 shown in FIG. 11 is [printf(“e=%d\n”, e);].

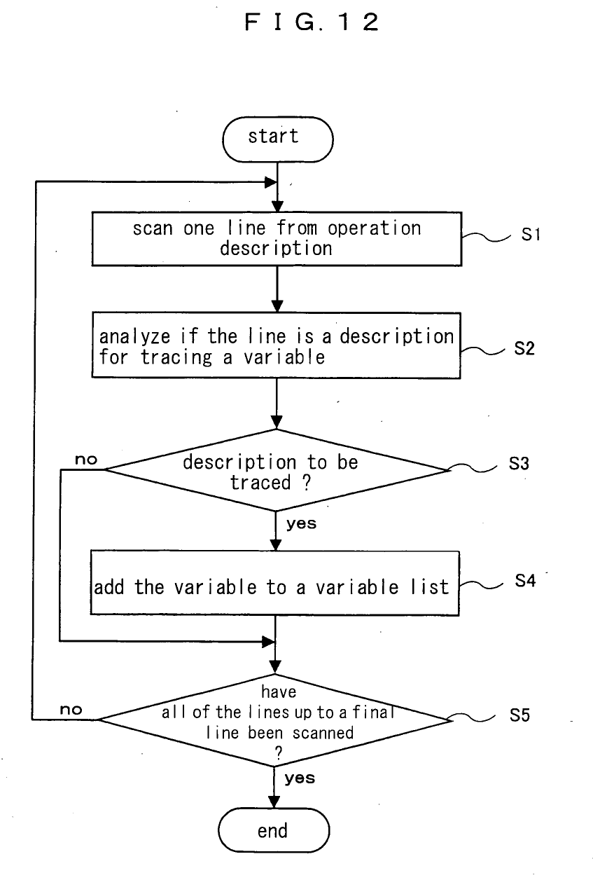

A method for the tracing object list generator 15 to analyze the operation description 21 shown in FIG. 11 is described referring to a flow chart of FIG. 12. First, one line is retrieved from the operation description 21 (S1). Next, it is analyzed whether or not the retrieved line is the tracing description for obtaining the transition history of the tracing object (S2). It is judged from a result of the analysis whether or not the retrieved line is the tracing description for obtaining the transition history of the tracing object (S3). In the case where the retrieved line is the tracing description, the relevant tracing object is added to the tracing object list 22 (S4). Next, it is confirmed whether or not the operation description 21 has been scanned up to the final line (S5). If the operation description 21 has not been scanned up to the final line, the processing returns to S1, in which one line is retrieved again from the operation description 21. When all of the lines up to the final line have been subjected the foregoing processing, the successive processing is terminated. In consequence of analyzing the operation description 21 shown in FIG. 11, the variable “e” is added to the tracing object list 22.

The tracing object list generator 15 can analyze any description as far as it is the tracing description for obtaining the transition history of the tracing object without any limitation to the tracing description (third line) in the operation description 21 shown in FIG. 11.

The tracing description generator for hardware description 12 generates the tracing description for hardware description 23 from the tracing object list 22 generated by the tracing object list generator 15 and the register allocation result 11.

The procedure for the tracing description generator for hardware description 12 to generate the tracing description for hardware description 23 were described in the preferred embodiment 1, and are not described again.

Further, there can be a case that the expression is described as the tracing object in the operation description 21. In such a case, the tracing object generator 15 can extract the expression whose transition history is to be obtained by analyzing the operation description 21.

In FIG. 10, the high order synthesizing apparatus A3 outputs the tracing object list 22, but the processing described below can be carried out without outputting the tracing object list 22. The high order synthesizing apparatus A3 automatically acknowledges the tracing object whose transition history is to be obtained therein, and the tracing description generator for hardware description 12 can generate the tracing description for hardware description 23 of the signal in the hardware description 20 corresponding to the acknowledged tracing object.

The tracing object list generator 15 can analyze, not only the operation description 21, but also any description including the information of the tracing object such as the register allocation result 11 and the lifetime information to thereby extract the tracing object.

### Preferred Embodiment 4

A high order synthesizing method according to a preferred embodiment 4 of the present invention is a method for generating the tracing description for hardware description by identifying the tracing object through the analysis of the register allocation result.

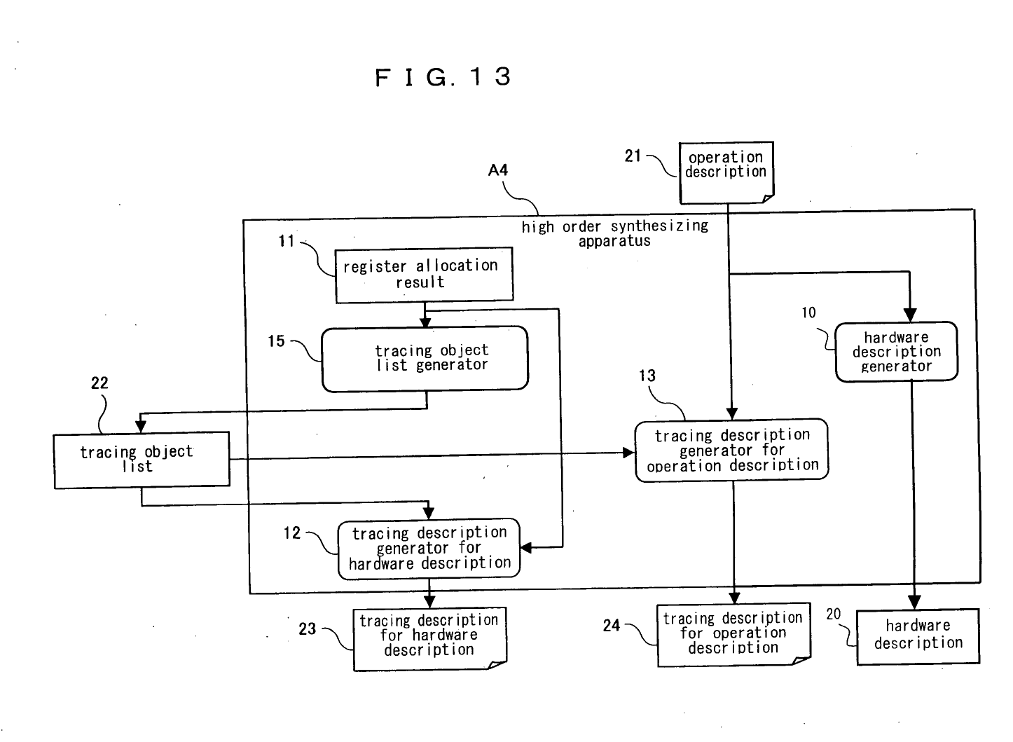

FIG. 13 shows a conceptual diagram for a constitution of a high order synthesizing apparatus according to the preferred embodiment 4. In FIG. 13, a high order synthesizing apparatus A4 comprises the hardware description generator 10, tracing description generator for hardware description 12, tracing description generator for operation description 13 and tracing object list generator 15. The tracing object list generator 15 analyzes the register allocation result 11 to thereby generate the tracing object list 22. The hardware description generator 10 generates the hardware description 20 from the operation description 21 in which the operation of the circuit to be designed is described. The tracing description generator for hardware description 12 generates the tracing description for hardware description 23 from the tracing object list 22 and the register allocation result 11. The tracing description generator for operation description 13 generates the tracing description for operation description 24 from the tracing object list 22 and the operation description 21.

The operation description 21, tracing object list 22 and register allocation result 11 are stored in the memory region accessible by the computer device. The computer device accesses the memory region to thereby execute the processing of the tracing description generator for hardware description 12, tracing description generator for operation description 13, tracing object list generator 15 and hardware description generator 10 using the internal CPU thereof to thereby generate the tracing description for hardware description 23, tracing description for operation description 24 and hardware description 20, and outputs them to the memory region again.

In order to efficiently identify a discrepant part, it is necessary to select the appropriate tracing object. The discrepant part can be speedily identified when the transition history of the tracing object storing the final computation result is obtained every time when the successive computations of the operation description 21 are executed. If any error is generated in the computations, the final computation result is consequently erroneous. Therefore, it can be confirmed whether or not the executed computations are accurate every time when the computation is executed by obtaining the transition history of the tracing object storing the final computation result.

The tracing object list generator 15 extracts the tracing object in which the final computation result is stored from the register allocation result 11 to thereby generate the tracing object list 22. The tracing object extracted by the tracing object list generator 15 can be any tracing object which is made the efficient verification. In the present case, the tracing object in which the final computation result is stored is mentioned as an example of the tracing object.

The present preferred embodiment is described referring to the operation description shown in FIG. 17 (d=a+b; e=c*d; b=a+e) as an example of the operation description 21.

The tracing object list generator 15 analyzes the register allocation result shown in FIG. 20. In the register allocation result shown in FIG. 20, the variable “b” is stored in the first register 36 as the final computation result in the control step 3. Therefore, the tracing object list generator 15 extracts the variable “b” as the tracing object whose transition history is to be obtained to thereby generate the tracing object list 22.

The tracing description generator for hardware description 12 generates the tracing description for hardware description 23 from the tracing object list 22 and the register allocation result 11. The procedure to generate the tracing description for hardware description 23 and the tracing description for operation description 24 were described in the preferred embodiment 1, and are not described again.

Further, in the register allocation result 11, the expression, other than the variable, may be allocated to the register. In such a case, the tracing object list generator 15 can analyze the register allocation result 11 to thereby extract the expression whose transition history is to be obtained.

Further, the tracing object list generator 15 can extract the tracing object through analysis of any description including the information of the tracing object such as the operation description 21 and the lifetime information, other than the register allocation result 11.

In addition, in FIG. 13, the high order synthesizing apparatus A4 outputs the tracing object list 22, which can be replaced by the processing described below without outputting the tracing object list 22 from the high order synthesizing apparatus A4. Namely, the high order synthesizing apparatus A4 automatically acknowledges the tracing object whose transition history is to be obtained therein, and the tracing description generator for hardware description 12 can generate the tracing description for hardware description 23 from the register allocation result 11 corresponding to the acknowledged tracing object.

### Preferred Embodiment 5

So far described the generation of the tracing description for hardware description corresponding to the tracing object which is allocated to the register, however, there can be a case that all of the tracing objects may not be allocated to the registers. In the scheduling processing in the high order synthesis, the plural computations is allocated in the control steps so that the various restrictions such as the clock restriction set by the user in the high order synthesis can be satisfied. In the CDFG, the data dependence branch traversing the clock boundary is allocated to the register, while the data dependence branch connecting between the computations present in the control step without traversing the clock boundary is not allocated to the register in general.

And so, in the preferred embodiment 5, a method for generating the tracing description for hardware description by identifying the signal in the hardware description 20 corresponding to the tracing object not allocated to the register is described.

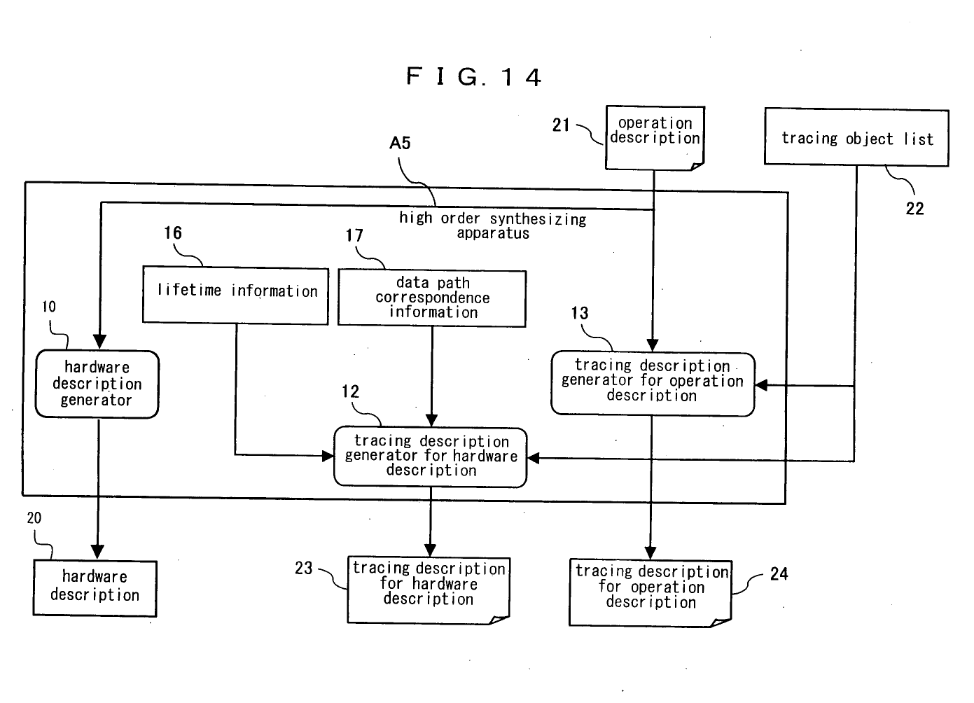

FIG. 14 shows a conceptual diagram for a constitution of a high order synthesizing apparatus according to the preferred embodiment 5. In FIG. 14, a high order synthesizing apparatus A5 comprises the hardware description generator 10, tracing description generator for hardware description 12, and tracing description generator for operation description 13. The tracing description generator for hardware description 12 generates the tracing description for hardware description 23 from the tracing object list 22, a data path correspondence information 17 and a lifetime information 16. The tracing description generator for operation description 13 generates the tracing description for operation description 24 from the tracing object list 22 and the operation description 21. The hardware description generator 10 generates the hardware description 20 from the operation description 21 in which the operation of the circuit to be designed is described.

The operation description 21, tracing object list 22, lifetime information 16 and data path correspondence information 17 are stored in the memory region accessible by the computer device. The computer device accesses the memory region to thereby execute the processing of the tracing description generator for hardware description 12, tracing description generator for operation description 13, and hardware description generator 10 using the internal CPU thereof to thereby generate the tracing description for hardware description 23, tracing description for operation description 24 and hardware description 20, and outputs these generated descriptions to the memory region again.

Below is described a method for generating the tracing description for hardware description 23 corresponding to the tracing object in the case that the tracing object is not allocated to the register referring to the operation description shown in FIG. 17 (d=a+b; e=c * d; b=a+e) as an example. Here as one example, the description is given referring to a particular case where the variable “d” is selected as the tracing object to obtain the transition history.

In the lifetime information shown in FIG. 19, the variable “d” is a variable which does not traverse the clock boundary and is therefore not allocated to the register. The process for generating the lifetime information shown in FIG. 19 from the operation description shown in FIG. 17 was described earlier.

In the high order synthesis, in general, the data dependence branch in the CDFG and the data path in hardware correspond to each other. FIG. 22 shows the data path correspondence information showing the correspondence relationship between the data dependence branch generated in the synthesis by the high order synthesizing apparatus A5 and the data path. The process for generating the data path correspondence information shown in FIG. 22 from the operation description shown in FIG. 17 was described earlier. The data path correspondence information shown in FIG. 22 shows the relationship how the data dependence branches in the CDFG in FIG. 18 and the data paths in FIG. 21 correspond to each other. The data path correspondence information shown in FIG. 22 shows that the data dependence branches r1, r2, r3, r4, r5 and r6 in the CDFG shown in FIG. 18 and the data paths p1, p2, p3, p4, p5 and p6 shown in FIG. 21 correspond to each other. The variable “d” corresponds to the data dependence branch r3 in the CDFG shown in FIG. 18. Accordingly, the data path corresponding to the variable “d” corresponds to the data path p3 shown in FIG. 5 according to the data path correspondence information shown in FIG. 22. Therefore, the data path corresponding to any variable not allocated to the register can be identified from the data path correspondence information 17.

Further, the control step for obtaining the transition history of the data path p3 in FIG. 21 corresponding to the variable “d” shown in FIG. 21 can be identified based on the lifetime information 16. In the lifetime information shown in FIG. 19, the variable “d” is present in the control step 1, and it is necessary to obtain the transition history in the control step 1.

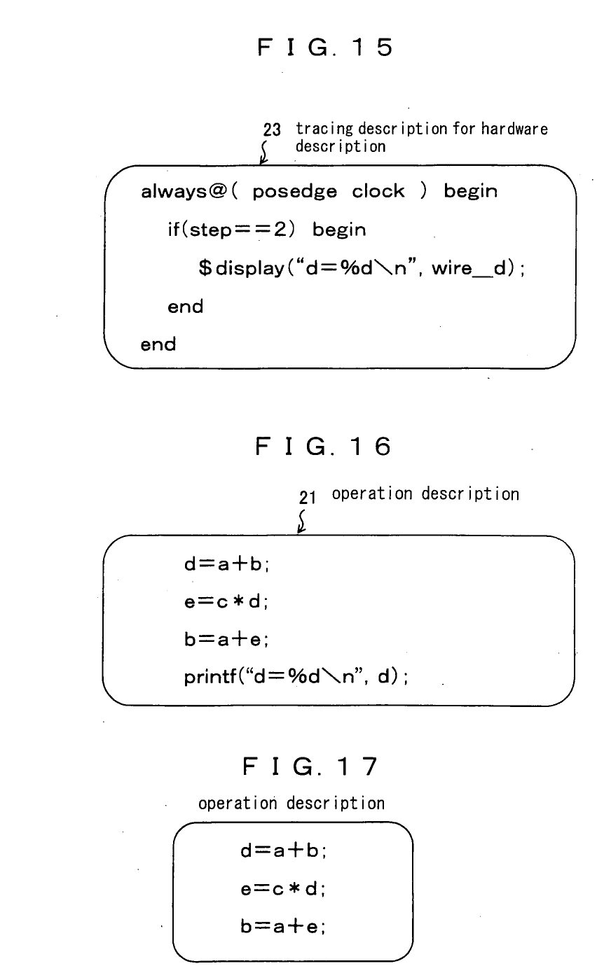

As described, the signal in the hardware description 20 corresponding to the data path p3 in FIG. 21 is obtained when the control step 1 is implemented so that the transition history of the signal in the hardware description 20 corresponding to the variable “d” can be obtained. FIG. 15 shows an example of the tracing description for hardware description 23 generated by the tracing description generator for hardware description 12. In FIG. 15, the Verilog-HDL language is used as its description language. It is assumed that the signal in FIG. 15, which is [wire_d], is the signal in the hardware description 20 corresponding to the data path p3 in FIG. 21. The tracing description for hardware description 23 shown in FIG. 15 has a function to output the data on the signal [wire_d] at the time of the control step 1.

FIG. 16 shows an example of the operation description 21 including the tracing description for operation description 24 for obtaining the transition history of the variable “d” generated by the tracing description generator for operation description 13. In the operation description 21 shown in FIG. 16, the ANCIC language is used as its description language. In the operation description 21 shown in FIG. 16, the tracing description [printf(“d=%d\n”, d)] for obtaining the transition history of the variable “d” is appended to the final line in the operation description 21.

The tracing description generator for hardware description 12 can generate the tracing description for hardware description 23 for obtaining the transition history of the signal in the hardware description 20 corresponding to the expression not allocated to the register except for the variable not allocated to the register. Further, the tracing description generator for operation description 13 can generate the tracing description for operation description 24 for obtaining the transition history of the expression except for the variable.

In FIG. 14, the tracing object list 22 is given to the high order synthesizing apparatus A5 from the outside thereof, however, the tracing object whose transition history is to be obtained can be acknowledged inside the high order synthesizing apparatus A5. The tracing description generator for hardware description 12 can generate the tracing description for hardware description 23 from the acknowledged tracing object, lifetime information 16 and data path correspondence information 17.

Though the preferred embodiments of this invention are explained in detail, it will be understood that various modifications may be made therein, and it is intended to cover in the appended claims all such modifications as fall within the true spirit and scope of this invention.

What is claimed is:

1. A high order synthesizing method comprising:
a step for generating a hardware description wherein an operation description is converted so as to make a hardware based on an operation description in which an operation of a circuit to be designed is described; and
a step for generating a tracing description for hardware description to obtain a transition history of one or a plurality of signals in the hardware description.

2. The high order synthesizing method according to claim 1, further comprising a step for generating a tracing description for operation description to obtain a transition history of a tracing object that is one or a plurality of variables or expressions in the operation description.

3. The high order synthesizing method according to claim 1, wherein
the tracing description for hardware description is produced to obtain a transition history of a signal in the hardware description corresponding to a tracing object which is one or a plurality of variables or expressions in the operation description in the step for generating the tracing description for hardware description.

4. The high order synthesizing method according to claim 3, wherein
the tracing description for hardware description is produced based on a register allocation result showing a correspondence relationship between the tracing object allocated to a register included in the hardware description and the register in the step for generating the tracing description for hardware description.

5. The high order synthesizing method according to claim 3, wherein
in a computation of the hardware description, the tracing description for hardware description is generated based on a time length when the tracing object corresponding to the signal in the hardware description is used, and a data path correspondence information showing a correspondence relationship between the tracing object and the signal in the hardware description in the step for generating the tracing description for hardware description.

6. The high order synthesizing method according to claim 3, wherein
a tracing object list in which the tracing objects are listed up is used as the tracing object in the step for generating the tracing description for hardware description.

7. The high order synthesizing method according to claim 6, further including a step for generating the tracing object list in which the tracing objects are listed up as the tracing object.

8. The high order synthesizing method according to claim 3, further including a step for generating a reference information to determine the tracing object.

9. The high order synthesizing method according to claim 6, further including a step for generating a reference information to determine the tracing object, wherein the tracing object list in which the tracing objects are listed up is selected by a user based on the reference information.

10. The high order synthesizing method according to claim 3, wherein
the tracing object is automatically acknowledged in the step for generating the tracing description for hardware description.

11. The high order synthesizing method according to claim 6, wherein
the tracing object list is generated based on a tracing object selection result made by a user based on the operation description in the step for generating the tracing description for hardware description.

12. The high order synthesizing method according to claim 7, wherein
the operation description includes a description for obtaining the transition history of the tracing object, and
the tracing object list is generated by analyzing the operation description in the step for generating the tracing object list.

13. The high order synthesizing method according to claim 7, wherein
the tracing object list is generated by analyzing a register allocation result showing a correspondence relationship between the tracing object allocated to a register included in the hardware description and the register in the step for generating the tracing object list.

14. The high order synthesizing method according to claim 7, wherein
the tracing object list is generated by a processing that the tracing object corresponding to the signal in the hardware description analyzes a time length that is used in a computation of the hardware description in the step for generating the tracing object list.

15. The high order synthesizing method according to claim 8, wherein
the reference information is generated from a register allocation result showing a correspondence relationship between the tracing object allocated to a register included in the hardware description and the register in the step for generating the reference information.

16. The high order synthesizing method according to claim 8, wherein
the reference information is generated from a time length when the tracing object corresponding to the signal in the hardware description is used in a computation of the hardware description in the step for generating the reference information.

17. The high order synthesizing method according to claim 8. wherein
the reference information is generated from the operation description including a description for obtaining the transition history of the tracing object in the step for generating the reference information.

18. The high order synthesizing method according to claim 10, wherein
the tracing object is automatically acknowledged by analyzing the operation description including a description for obtaining the transition history of the tracing object in the step for generating the tracing description for hardware description.

19. The high order synthesizing method according to claim 10, wherein
the tracing object is automatically acknowledged through a processing that a register allocation result showing a correspondence relationship between the tracing object allocated to a register included in the hardware description and the register is analyzed in the step for generating the tracing description for hardware description.

20. The high order synthesizing method according to claim 10, wherein
the tracing object is automatically acknowledged through a processing that the tracing object corresponding to the signal in the hardware description analyzes a time length when it is used in a computation of the hardware description in the step for generating the tracing description for hardware description.

21. A high order synthesizing apparatus comprising:
a hardware description generator for generating a hardware description wherein an operation description is converted to hardware based on an operation description in which an operation of a circuit to be designed is described; and
a tracing description generator for hardware description for generating a tracing description for hardware description to obtain a transition history of one or a plurality of signals in the hardware description.

22. The high order synthesizing apparatus according to claim 21, further comprising a tracing description generator for operation description to generate a tracing description for operation description so as to obtain a transition history of a tracing object which is one or a plurality of variables or expressions in the operation description.

23. The high order synthesizing apparatus according to claim 21, wherein
the tracing description generator for hardware description generates the tracing description for hardware description to obtain the transition history of the signal in the hardware description corresponding to a tracing object which is one or a plurality of variables or expressions in the operation description.

24. The high order synthesizing apparatus according to claim 23, wherein
the tracing description generator for hardware description generates the tracing description for hardware description from a register allocation result showing a correspondence between the tracing object allocated to a register included in the hardware description and the register.

25. The high order synthesizing apparatus according to claim 23, wherein
the tracing description generator for hardware description generates the tracing description for hardware description from a time length when the tracing object corresponding to the signal in the hardware description is used in a computation of the hardware description and a data path correspondence information showing a correspondence between the tracing object and the signal in the hardware description.
